(19) United States
(12) Patent Application Publication
(10) Pub. No.: US 2026/0070680 A1
(43) Pub. Date: Mar. 12, 2026

(54) SYSTEM FOR RETENTION AND DEPLOYMENT OF SPACE VEHICLES

(71) Applicant: NETWORK ACCESS ASSOCIATES LIMITED, London (GB)

(72) Inventors: Dominique PONCET, London (GB); Manraj NAGI, London (GB)

(21) Appl. No.: 18/812,061

(22) Filed: Aug. 22, 2024

Related U.S. Application Data
(63) Continuation of application No. PCT/IB2023/000091, filed on Feb. 24, 2023.

(30) Foreign Application Priority Data
Feb. 25, 2022 (FR) 2201682

(51) Int. Cl. B64G 1/64

(52) U.S. Cl. CPC B64G 1/6457; B64G 1/643

(57) ABSTRACT

A space vehicle includes a body; a stacking pillar coupled to an exterior of the body and defining a longitudinal axis, wherein the stacking pillar is configured to be removably coupled to a stacking pillar of an adjacent space vehicle; and an engagement mechanism including: a pivot point within the stacking pillar defining a pivot axis perpendicular to the longitudinal axis; and a mounting post positioned within the stacking pillar and pivotably engaged with the pivot point so as to be pivotable about the pivot axis between a locked position and an unlocked position, wherein the mounting post is spring-biased to the unlocked position, and wherein the mounting post is configured to restrain the space vehicle from movement away from the adjacent space vehicle when the mounting post is positioned in the locked position and a mounting post of the adjacent space vehicle is positioned in a locked position.

### FIELD OF THE INVENTION

The field of the invention relates to retention systems for retention of space vehicles on a launch vehicle base. More particularly, the field of the invention relates to retention systems for satellites, in which the satellite includes the components of the retention system within a portion of the satellite.

### BACKGROUND OF THE INVENTION

Satellites typically include stacking pillars that cooperate with stacking pillars of adjacent satellites to retain satellites in a launch stack on a launch vehicle. Typically, the stacking pillars are retained in position within a launch stack through the use of tie rods. Additionally, standard techniques for releasing satellites from a stack involve the inclusion of separation systems between each pair of satellites, which are each triggered by individual instructions.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 shows a perspective view of an exemplary space vehicle.

FIG. 2 shows a cutaway perspective view of a pillar of an exemplary engagement mechanism.

FIG. 3 shows a pivoting rod of an exemplary engagement mechanism.

FIG. 4A shows a biasing spring of an exemplary engagement mechanism.

FIG. 4B shows a biasing spring of an exemplary engagement mechanism.

FIG. 5A shows an exemplary space vehicle retention system in a locked position.

FIG. 5B shows the exemplary space vehicle retention system of FIG. 5A in an unlocked position.

FIG. 6A shows a first stage of use of an exemplary locking pin and exemplary biasing spring to position an exemplary pivoting rod.

FIG. 6B shows a second stage of use of an exemplary locking pin and exemplary biasing spring to position an exemplary pivoting rod.

FIG. 6C shows a third stage of use of an exemplary locking pin and exemplary biasing spring to position an exemplary pivoting rod.

FIG. 6D shows a fourth stage of use of an exemplary locking pin and exemplary biasing spring to position an exemplary pivoting rod.

FIG. 6E shows a fifth stage of use of an exemplary locking pin and exemplary biasing spring to position an exemplary pivoting rod.

FIG. 6F shows a sixth stage of use of an exemplary locking pin and exemplary biasing spring to position an exemplary pivoting rod.

FIG. 7 shows a perspective view of an exemplary space vehicle.

### SUMMARY OF THE INVENTION

In some embodiments, a system includes a space vehicle having stacking pillar and a mounting post pivotably mounted within the stacking pillar, wherein the mounting post is pivotable between a locked position and an unlocked position, wherein the mounting post is biased to the unlocked position, and wherein the mounting post and a mounting post of an adjacent space vehicle, when positioned in the locked position, cooperate to retain the space vehicle and the adjacent space vehicle in proximity to one another.

In some embodiments, a system includes a plurality of space vehicles, wherein each of the plurality of space vehicles includes an engagement mechanism, and wherein the engagement mechanism includes a stacking pillar, wherein the stacking pillar defines a longitudinal axis, and wherein the stacking pillar is configured to be removably coupled to a stacking pillar of a further one of the plurality of space vehicles that is positioned on an adjacent layer of a stack of the plurality of space vehicles; a pivot point positioned within the stacking pillar, wherein the pivot point defines a pivot axis that is oriented perpendicular to the longitudinal axis; a mounting post positioned within the stacking pillar, wherein the mounting post is pivotably engaged with the pivot point so as to be pivotable about the pivot axis between a locked position and an unlocked position, wherein the mounting post is spring-biased to the unlocked position, and wherein the mounting post is configured such that, when (a) a first one of the plurality of space vehicles is positioned adjacent to a second one of the plurality of space vehicles such that the stacking pillar of the first one of the plurality of space vehicles is coupled to the stacking pillar of the second one of the plurality of space vehicles, (b) the mounting post of the first one of the plurality of space vehicles is positioned in the locked position, and (c) the mounting post of the second one of the plurality of space vehicles is positioned in the locked position, the mounting post of the first one of the plurality of space vehicles and the mounting post of the second one of the plurality of space vehicles cooperate to restrain first one of the plurality of space vehicles and the second one of the plurality of space vehicles from moving away from one another; and a retention mechanism, wherein the retention mechanism is configured to apply a retention force to the mounting post of one of the plurality of space vehicles, and wherein the retention force is configured to act against the spring-biasing so as to retain the mounting post of the one of the plurality of space vehicles in the locked position.

In some embodiments, the engagement mechanism also includes a spring, and the spring is configured to spring-bias the mounting post to the unlocked position. In some embodiments, the spring includes one of a blade spring, a coil spring, or a spiral spring. In some embodiments, the stacking pillar also includes an opening passing therethrough at a location proximate to the spring, and the engagement mechanism also includes a pin selectively receivable within or removable from the opening. In some embodiments, the pin is configured to contact the mounting post so as to prevent the mounting post from moving from the locked position to the unlocked position when the pin is received within the opening.

In some embodiments, the retention mechanism includes a motor operable to selectively apply or release the retention force. In some embodiments, the motor is positioned at a bottom of a stack comprising the plurality of space vehicles. In some embodiments, the motor is configured to provide the retention force that is in a range of 10 kilonewtons to 1,000 kilonewtons. In some embodiments, the motor is configured to release the retention force upon receipt of a signal. In some embodiments, the motor is configured to release the retention force at a predetermined time. In some embodiments, the motor is configured to release the retention force when the system is at a predetermined location.

In some embodiments, a space vehicle includes a space vehicle body; a stacking pillar coupled to an exterior of the space vehicle body, wherein the stacking pillar defines a longitudinal axis, and wherein the stacking pillar is configured to be removably coupled to a stacking pillar of an adjacent space vehicle positioned above or below the space vehicle; and an engagement mechanism, wherein the engagement mechanism includes: a pivot point positioned within the stacking pillar, wherein the pivot point defines a pivot axis that is oriented perpendicular to the longitudinal axis; and a mounting post positioned within the stacking pillar, wherein the mounting post is pivotably engaged with the pivot point so as to be pivotable about the pivot axis between a locked position and an unlocked position, wherein the mounting post is spring-biased to the unlocked position, and wherein the mounting post is configured so as to restrain the space vehicle from movement away from the adjacent space vehicle when the mounting post is positioned in the locked position and a mounting post of the adjacent space vehicle is positioned in a locked position.

In some embodiments, the engagement mechanism is contained within the stacking pillar.

### DETAILED DESCRIPTION OF THE INVENTION

Throughout the specification, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on. ”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or,” or with the conjunction “and. ” In either case, the set is to be interpreted as meaning each of the items singularly as alternatives, as well as any combination of the listed items.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The exemplary embodiments described herein relate to space vehicles, such as satellites. More particularly, the exemplary embodiments described relate to mechanisms for retaining space vehicles, such as stacks of satellites, in place while mounted to a launch vehicle, and to releasing such space vehicles from their retained locations when appropriate.

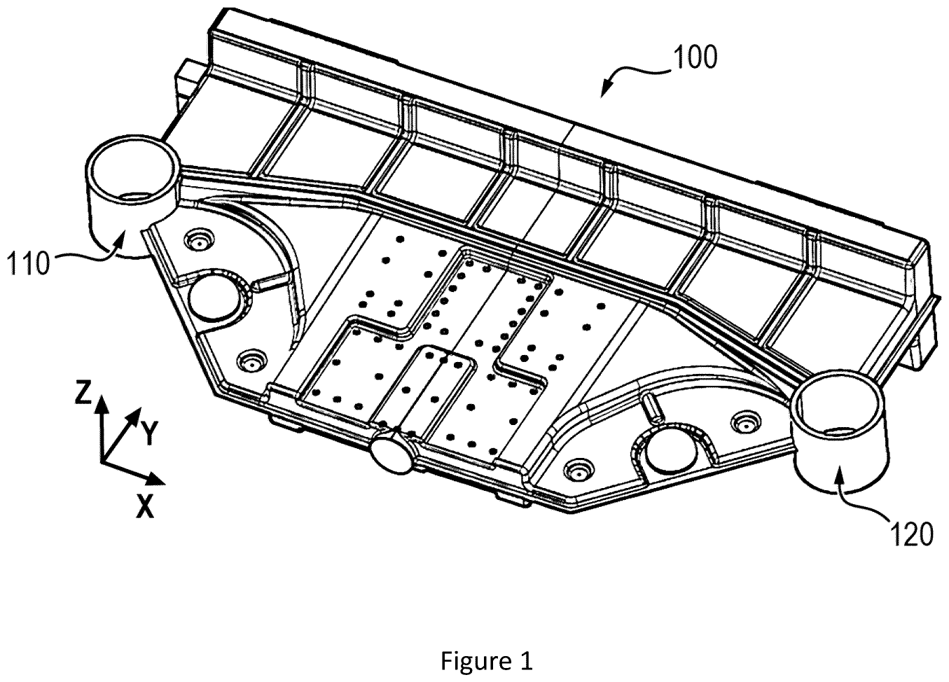

FIG. 1 shows a perspective view of an exemplary space vehicle 100. In some embodiments, the exemplary space vehicle includes stacking pillars 110, 120 positioned at opposite sides of the exterior of the body of the space vehicle 100.

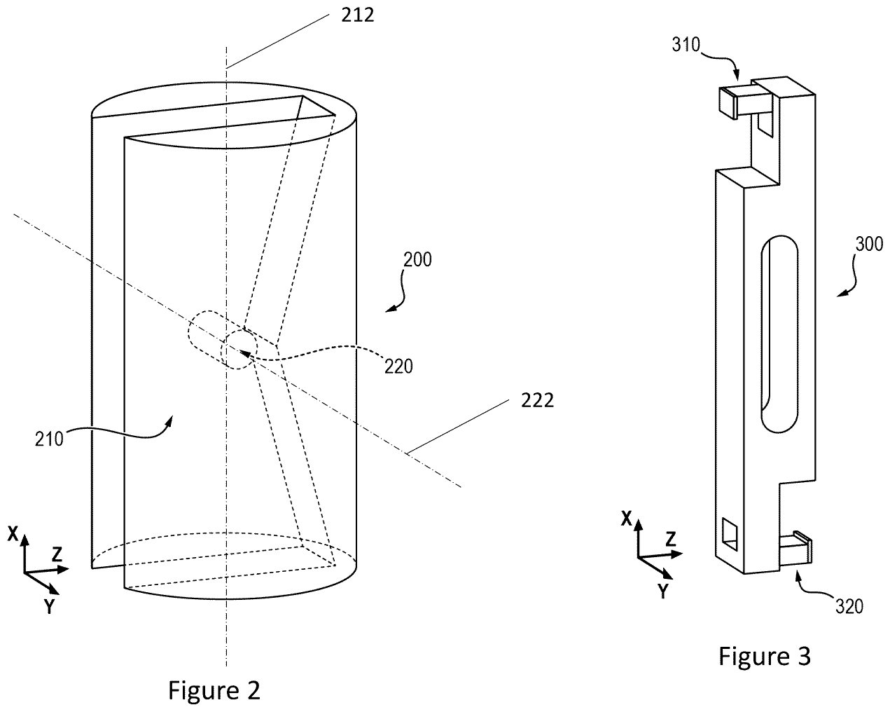

In some embodiments, the space vehicle 100 includes an engagement mechanism 200. In some embodiments, the engagement mechanism 200 includes a stacking pillar 210 (e.g., one of the stacking pillars 110, 120 of the space vehicle 100) and a pivoting rod 300. In some embodiments, the stacking pillar defines a longitudinal axis 212. In some embodiments, the engagement mechanism 200 includes a mounting post 220 positioned within the stacking pillar 210. In some embodiments, the mounting post 220 defines a pivot axis 222. In some embodiments, the pivot axis 222 is perpendicular to the longitudinal axis 212. FIG. 2 shows a stacking pillar 210 with a portion thereof rendered transparently to show the position of the mounting post 220. In some embodiments, the elements of the engagement mechanism 200, other than the stacking pillar 210 itself, are contained within the stacking pillar 210.

In some embodiments, the engagement mechanism 200 includes a pivoting rod pivotably engaging the mounting post. FIG. 3 shows an exemplary pivoting rod 300. In some embodiments, the pivoting rod 300 is pivotably engaged to the mounting post 220 such that the mounting post 220 acts as a pivot point about which the pivoting rod 300 is able to pivot. In some embodiments, the pivoting rod 300 is pivotable between a locked position and an unlocked position. In some embodiments, when in the locked position, the pivoting rod 300 is oriented substantially longitudinally along a longitudinal axis of the mounting post 220. In some embodiments, when in the unlocked position, the pivoting rod 300 is angled with respect to the longitudinal axis of the mounting post 220.

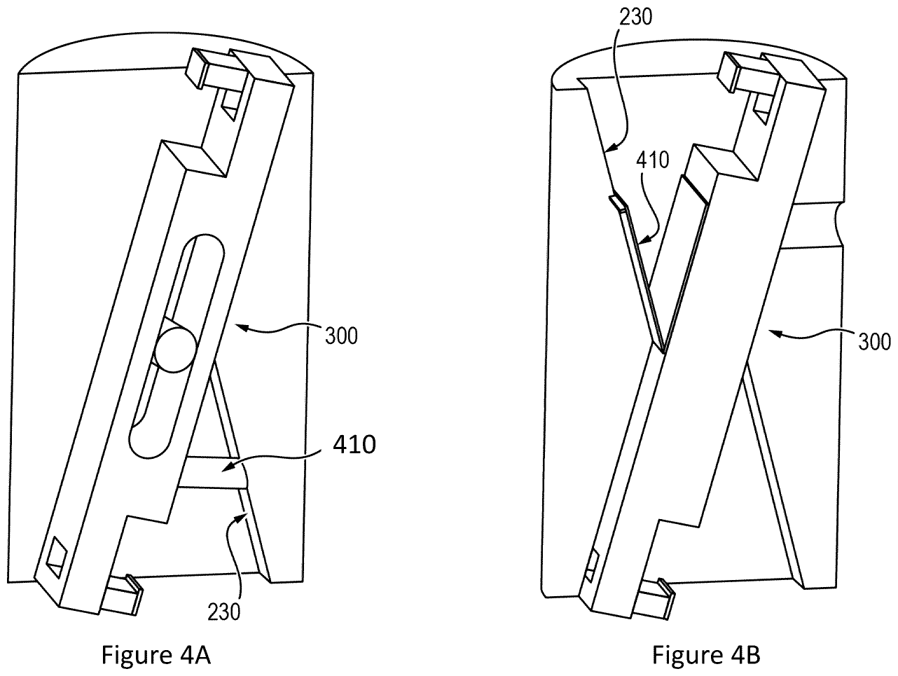

In some embodiments, the pivoting rod 300 is spring-biased within the mounting post 220 so as to be biased toward the unlocked position. FIGS. 4A and 4B show embodiments of the pivoting rod 300 as positioned in the unlocked position. FIG. 4A shows a first embodiment including a spring 410 that is configured (e.g., sized, shaped, and positioned) to bias the pivoting rod 300 in the unlocked position. FIG. 4B shows a second embodiment including a spring 410 that is configured (e.g., sized, shaped, and positioned) to bias the pivoting rod 300 in the unlocked position. As shown in FIGS. 4A and 4B, in some embodiments, the interior of the pivoting rod 300 includes an angled surface 230 that is oriented so as to allow the spring 410 to act against the angled surface 230, thereby to bias the pivoting rod 300 to the unlocked position.

In some embodiments, the spring 410 may be any type of spring that is capable of being positioned as shown in FIG. 4A or FIG. 4B and acting in the manner described (e.g., biasing the pivoting rod 300 to the unlocked position). For example, in some embodiments, the spring 410 includes a blade spring, a coil spring, or a spiral spring. In some embodiments, the spring 410 is configured to provide a sufficient force to overcome friction (e.g., friction between the pivoting rod 300 of the engagement mechanism 200 of a first one of a plurality of the space vehicle 100 and the pivoting rod 300 of the engagement mechanism of an adjacent second one of the plurality of the space vehicle 100) in order to force the pivoting rod 300 into its unlocked position. In some embodiments, the spring 410 is positioned in the engagement mechanism 200 together with a damper in order to cause the pivoting rod 300 to move smoothly and not bump the interior of the mounting post 220 upon opening.

Referring back to FIG. 3, In some embodiments, the pivoting rod 300 includes a first hook 310 at a first end thereof and a second hook 320 at a second end thereof. In some embodiments, the hooks 310, 320 are configured (e.g., sized, shaped, and positioned) such that when one of the hooks 310, 320 engages one of the hooks 310, 320 of an adjacent pivoting rod 300 and a tension force is applied along the pivoting rods 300, the hooks 310, 320 cooperate to retain the pivoting rods 300 in the locked position rather than in the unlocked position. In some embodiments, the hooks 310, 320 are identical to one another and the pivoting rod 300 is longitudinally symmetric, such that the pivoting rod 300 is substantially identical if oriented such that the first hook 310 is oriented upward, or if inverted to be oriented such that the second hook 320 is oriented upward.

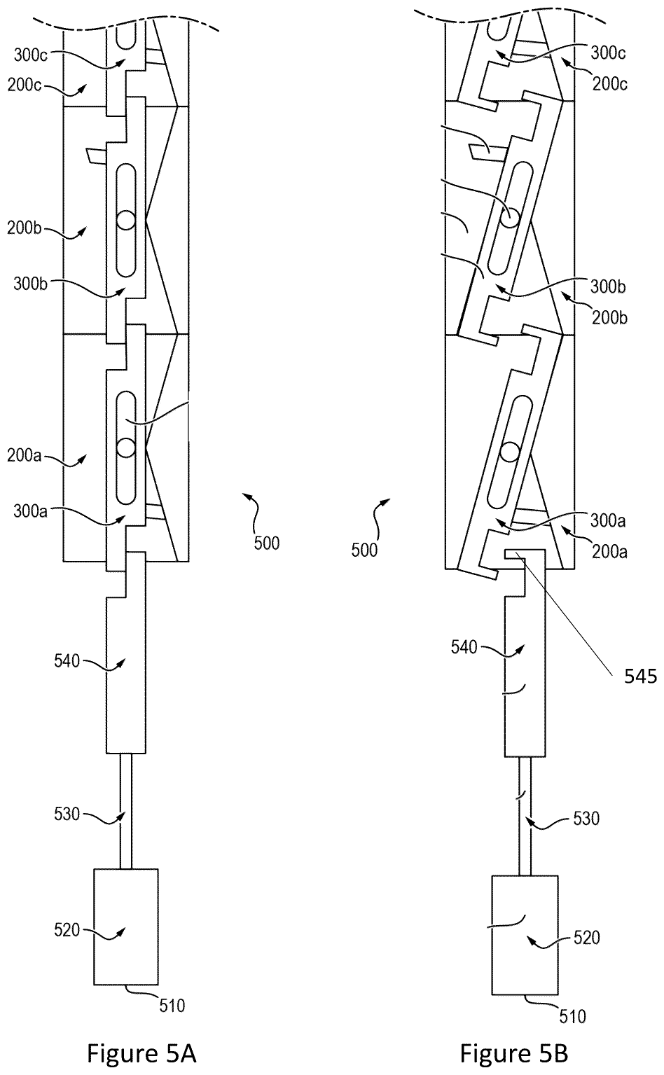

FIGS. 5A and 5B show an exemplary space vehicle retention system 500. In some embodiments, the space vehicle retention system 500 includes one or more of the space vehicle 100, wherein each of the space vehicle 100 includes one or more of (e.g., two of) the engagement mechanism 200. In some embodiments, the space vehicle retention system 500 also includes an anchoring device 510. In some embodiments, the anchoring device 510 is integrated into a launch vehicle. In some embodiments, the anchoring device is mounted to a launch vehicle.

In some embodiments, the anchoring device 510 includes a motor 520 fixed to (e.g., integrated into or mounted to) a launch vehicle. In some embodiments, the motor 520 is coupled to a worm screw 530 such that the motor 520 rotates the worm screw 530 when the motor 520 is active. In some embodiments, the anchoring device 510 includes a rod 540 positioned at an end of the worm screw 530 opposite the motor 520. In some embodiments, the rod 540 includes a hook 545 that is configured (e.g., sized and shaped) to engage the hooks 310, 320 of the pivoting rod 300.

FIG. 5A shows the space vehicle retention system 500 in a locked position. In the position shown in FIG. 5A, three space vehicles 100 including respective ones 200a, 200b, 200c of the engagement mechanism 200 have been stacked on a launch vehicle including the anchoring device 510. Respective pivoting rods 300a, 300b, 300c of the engagement mechanisms 200a, 200b, 200c of the space vehicles 100 have been positioned in their respective locked positions, and the motor 520 has been operated to position the rod 540 in a position such that the rod 540 applies a tension to the pivoting rod 300a. In some embodiments, the motor 520 is operable to selectively apply or release the tension as described herein. As a result of this tension, the pivoting rod 300a is retained in its locked position, and applies resulting tensions to the pivoting rods 300b and 300c, thereby retaining the pivoting rods 300b and 300c also in their locked positions. As such, the space vehicles 100 including the engagement mechanisms 200a, 200b, 200c are retained in position on the launch vehicle including the anchoring device 510. In some embodiments, the tension applied in this manner is sufficient to retain a plurality of space vehicles 100 in proximity to one another in a stack as described herein (e.g., to restrain the space vehicles 100 from moving away from one another). In some embodiments, a suitable tension may vary depending on factors such as the overall mass of the stack and the loads to be handled (e.g., which may vary depending on factors such the type of launch vehicle being utilized). In some embodiments the tension is in a range of from 10 kilonewtons (kN) to 1,000 kN, or is in a range of from 50 kN to 1,000 kN, or is in a range of from 100 kN to 1,000 kN, or is in a range of from 10 kN to 750 kN, or is in a range of from 50 kN to 750 kN, or is in a range of from 100 kN to 750 kN, or is in a range of from 10 kN to 500 kN, or is in a range of from 50 kN to 500 kN, or is in a range of from 100 kN to 500 kN.

FIG. 5B shows the space vehicle retention system 500 in an unlocked position. When the space vehicles 100 retained by the space vehicle retention system 500 are to be released and allowed to separate from a launch vehicle, the motor 520 is activated. For example, in some embodiments, the motor receives an activation signal via a communication interface of the launch vehicle. In some embodiments, the motor is preconfigured to activate at a particular (e.g., predetermined) time or in a particular (e.g., predetermined) location. When the motor 520 is activated, the worm screw 530 is rotated, causing the rod 540 to move away from the motor 520. As a result of motion of the rod 540 away from the motor, the tension previously applied to the pivoting rod 300 is released. Once tension is released, the pivoting rods 300a, 300b, 300c are moved to their respective unlocked positions due to operation of the corresponding springs 410. Once the pivoting rods 300a, 300b, 300c have moved to their respective unlocked positions, the engagement mechanisms 200a, 200b, 200c are no longer active to retain the space vehicles 100 in a stack on the launch vehicle. The space vehicles 100 are then free to be deployed.

FIGS. 5A and 5B show one of the exemplary space vehicle retention system 500 that retains three of the space vehicles 100. However, it will be apparent to those of skill in the art that these quantities are only illustrative. For example, other embodiments of a launch vehicle may include any other quantity (e.g., four, six, etc.) of the space vehicle retention system 500. Additionally, it will be apparent to those of skill in the art that a given one of the space vehicle may be coupled to more than one of the space vehicle retention system 500. For example, the space vehicle 100 shown in FIG. 1 includes two of the engagement mechanism 200, and therefore may be retained in a desired position by two of the space vehicle retention system 500. Similarly, each given space vehicle retention system 500 may retain a stack including any number of the space vehicles 100 including the engagement mechanisms 200.

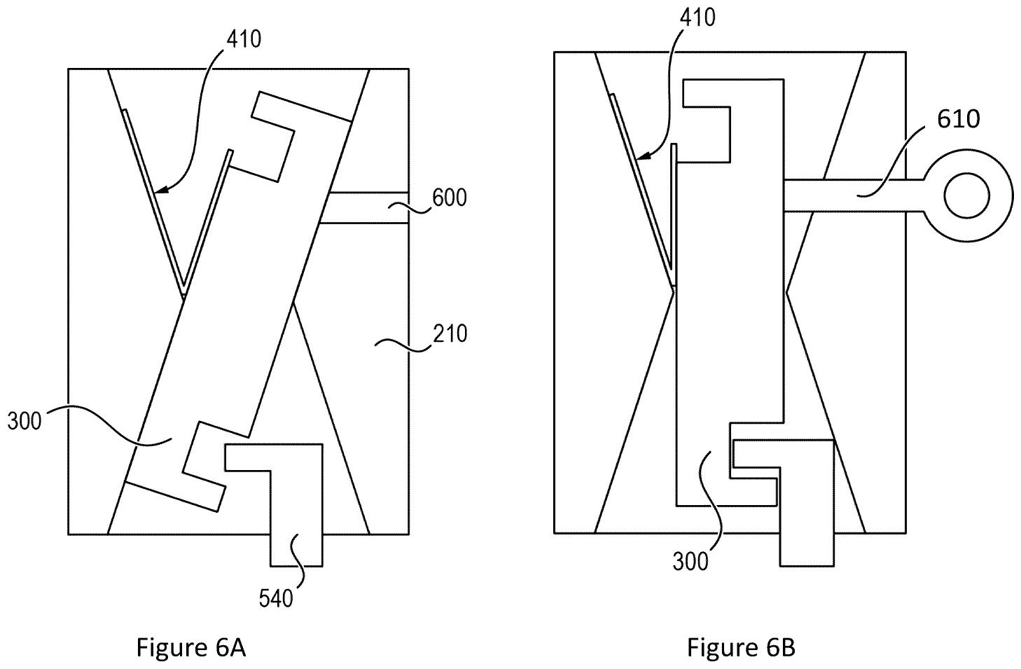

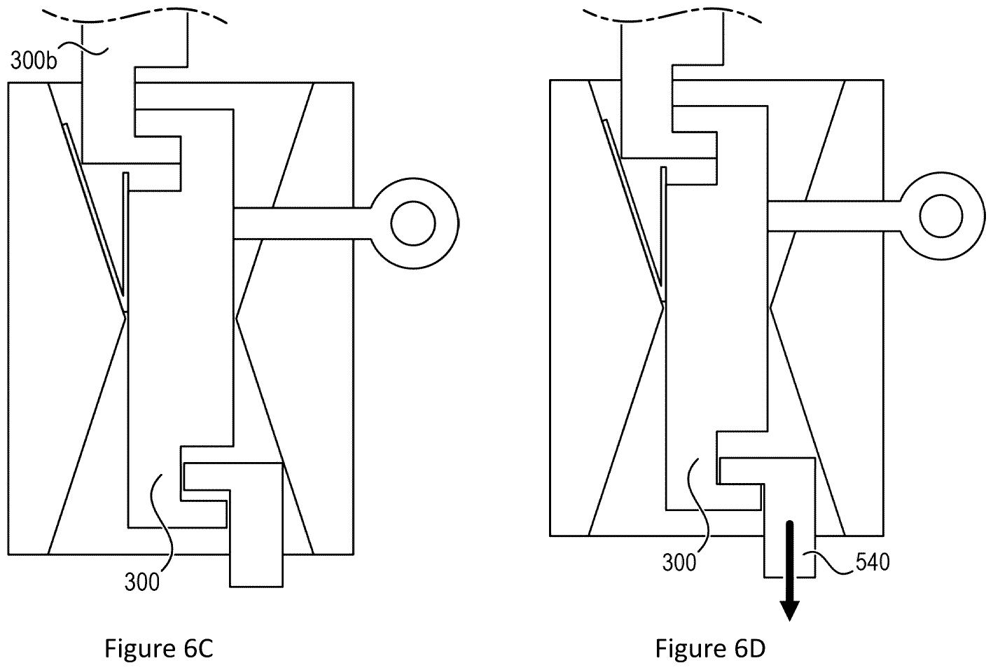

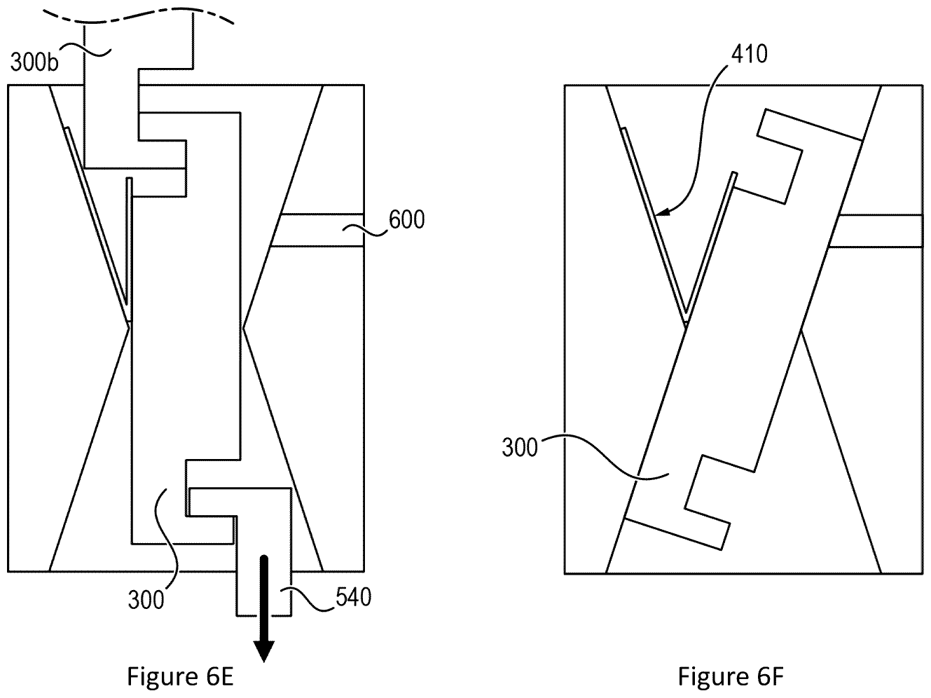

In some embodiments, a locking pin is used to place the pivoting rods 300 into the locked position prior to engagement of the space vehicle retention system 500, and an opening is provided in the stacking pillars 210 (e.g., passing through the stacking pillars 210) to accommodate for such a locking pin. FIGS. 6A-6F show a sequence of steps for use of a locking pin in conjunction with a stacking pillar 210 having the biasing spring 410 shown in FIG. 4B. FIG. 6A shows a stacking pillar 210 in which the pivoting rod 300 is positioned in the unlocked position. In the embodiment of the stacking pillar 210 shown in FIG. 6A, an opening 600 is provided in a position aligned with the biasing spring 410. As shown in FIG. 6A, the stacking pillar 210 is at the bottom of an exemplary stack, and is adjacent to a rod 540, as described above with reference to FIGS. 5A-5B.

In FIG. 6B, a locking pin 610 is positioned in the opening 600. In some embodiments, the locking pin 610 is selectively receivable within or removable from the opening 600. In some embodiments, the locking pin 610 and the opening 600 are threaded so as to engage one another in order to retain the locking pin 610 within the opening 600. By placing the locking pin 610 into the opening 600 as shown in FIG. 6B, the biasing spring 410 is compressed and the pivoting rod 300 is placed in its locking position. The locking pin 610 prevents the biasing spring 410 from returning the pivoting rod 300 to its unlocked position.

In FIG. 6C, a further space vehicle has been added to a stack atop the space vehicle including the stacking pillar 210 shown in FIGS. 6A-6B. The pivoting rod 300b of the further space vehicle has also been positioned in the locked position, e.g., in the same manner as described above with reference to FIG. 6B.

In FIG. 6D, with the locking pin 610 remaining in place so as to contact the pivoting rod 300 and thereby retain the pivoting rod 300 in its locked position, the rod 540 is actuated to apply a tension to the pivoting rod 300 in the manner described above with reference to FIGS. 5A-5B. In FIG. 6E, prior to launch, the locking pin 610 is removed from the opening 600. The rod 540 applies tension to the pivoting rod 300 to thereby maintain the pivoting rod 300 in its locked position. The pivoting rod 300 applies a corresponding tension to the adjacent pivoting rod 300b, and so on along aligned stacking pillars within the stack, thereby retaining all abutting pivoting rods also in their locked positions.

After launch, the rod 540 is activated to remove tension from the pivoting rod 300 as described above with reference to FIGS. 5A-5B. As shown in FIG. 6F, as a result of removal of tension, the biasing spring activates to return the pivoting rod 300 to its unlocked position. Correspondingly, the pivoting rod 300 no longer applies tension to the pivoting rod 310b of the adjacent space vehicle as shown in FIG. 6E, and so on along the stack. As such, the various space vehicles within the stack are able to move away from one another.

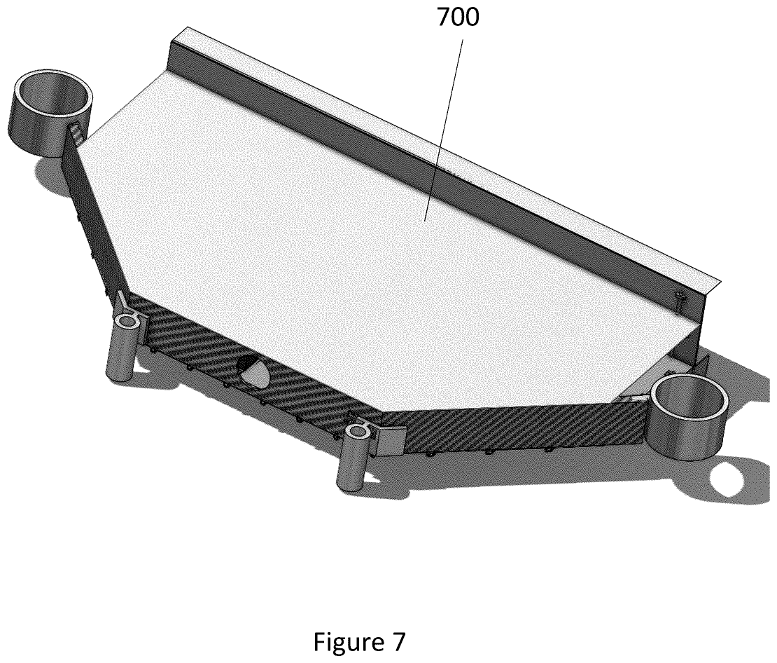

The exemplary embodiments described above have been described with reference to an exemplary space vehicle 100 that includes two stacking pillars 110, 120 positioned at opposite sides of the space vehicle 100. In other embodiments, an exemplary space vehicle may include a different quantity of stacking pillars (e.g., three stacking pillars, four stacking pillars, five stacking pillars, six stacking pillars, etc.). FIG. 7 shows an embodiment of a space vehicle 700 that includes four stacking pillars. More particularly, in the embodiment shown in FIG. 7, the space vehicle 700 includes stacking pillars 710 and 720 that are positioned in substantially the same manner as the stacking pillars 110 and 120 described above with reference to FIG. 1. In the embodiment shown in FIG. 7, the space vehicle 700 also includes stacking pillars 730 and 740. In some embodiments, the stacking pillars 710 and 720 include engagement mechanisms 200 as described above, and the stacking pillars 730 and 740 do not include engagement mechanisms. In some embodiments, the stacking pillars 710, 720, 730, and 740 all include engagement mechanisms 200 as described above.

The exemplary embodiments described herein provide retention of space vehicles such as satellites within stacks on a launch vehicle. In the exemplary embodiments, each satellite includes its own retention hooks as internal elements thereof. The exemplary embodiments described herein are therefore scalable to include a greater or lesser number of satellites in a stack on a given launch vehicle without needing to change elements of the overall structure (e.g., to provide longer or shorter tie rods). The exemplary embodiments described herein can further be used to retain satellites in any arrangement within a stack (e.g., four satellites per layer, six satellites per layer, etc.). The exemplary embodiments described herein also enable release of satellites from a stack through the use of only a single release mechanism for each pillar.

While a number of embodiments of the present invention have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

What is claimed is:

1. A system, comprising:
a plurality of space vehicles, wherein each of the plurality of space vehicles comprises an engagement mechanism, and wherein the engagement mechanism comprises:
a stacking pillar,
wherein the stacking pillar defines a longitudinal axis, and
wherein the stacking pillar is configured to be removably coupled to a stacking pillar of a further one of the plurality of space vehicles that is positioned on an adjacent layer of a stack of the plurality of space vehicles;
a pivot point positioned within the stacking pillar,
wherein the pivot point defines a pivot axis that is oriented perpendicular to the longitudinal axis;
a mounting post positioned within the stacking pillar,
wherein the mounting post is pivotably engaged with the pivot point so as to be pivotable about the pivot axis between a locked position and an unlocked position,
wherein the mounting post is spring-biased to the unlocked position, and
wherein the mounting post is configured such that, when
(a) a first one of the plurality of space vehicles is positioned adjacent to a second one of the plurality of space vehicles such that the stacking pillar of the first one of the plurality of space vehicles is coupled to the stacking pillar of the second one of the plurality of space vehicles,
(b) the mounting post of the first one of the plurality of space vehicles is positioned in the locked position, and
(c) the mounting post of the second one of the plurality of space vehicles is positioned in the locked position,
the mounting post of the first one of the plurality of space vehicles and the mounting post of the second one of the plurality of space vehicles cooperate to restrain first one of the plurality of space vehicles and the second one of the plurality of space vehicles from moving away from one another; and
a retention mechanism,
wherein the retention mechanism is configured to apply a retention force to the mounting post of one of the plurality of space vehicles, and
wherein the retention force is configured to act against the spring-biasing so as to retain the mounting post of the one of the plurality of space vehicles in the locked position.

2. The system of claim 1, wherein the engagement mechanism further comprises a spring, and wherein the spring is configured to spring-bias the mounting post to the unlocked position.

3. The system of claim 2, wherein the spring comprises one of a blade spring, a coil spring, or a spiral spring.

4. The system of claim 2,
wherein the stacking pillar further comprises an opening passing therethrough at a location proximate to the spring, and
wherein the engagement mechanism further comprises a pin selectively receivable within or removable from the opening.

5. The system of claim 4, wherein the pin is configured to contact the mounting post so as to prevent the mounting post from moving from the locked position to the unlocked position when the pin is received within the opening.

6. The system of claim 1, wherein the retention mechanism comprises a motor operable to selectively apply or release the retention force.

7. The system of claim 6, wherein the motor is positioned at a bottom of a stack comprising the plurality of space vehicles.

8. The system of claim 6, wherein the motor is configured to provide the retention force that is in a range of 10 kilonewtons to 1,000 kilonewtons.

9. The system of claim 6, wherein the motor is configured to release the retention force upon receipt of a signal.

10. The system of claim 6, wherein the motor is configured to release the retention force at a predetermined time.

11. The system of claim 6, wherein the motor is configured to release the retention force when the system is at a predetermined location.

12. A space vehicle, comprising:
a space vehicle body;
a stacking pillar coupled to an exterior of the space vehicle body,
wherein the stacking pillar defines a longitudinal axis, and
wherein the stacking pillar is configured to be removably coupled to a stacking pillar of an adjacent space vehicle positioned above or below the space vehicle; and
an engagement mechanism, wherein the engagement mechanism comprises:
a pivot point positioned within the stacking pillar,
wherein the pivot point defines a pivot axis that is oriented perpendicular to the longitudinal axis; and
a mounting post positioned within the stacking pillar,
wherein the mounting post is pivotably engaged with the pivot point so as to be pivotable about the pivot axis between a locked position and an unlocked position,
wherein the mounting post is spring-biased to the unlocked position, and
wherein the mounting post is configured so as to restrain the space vehicle from movement away from the adjacent space vehicle when the mounting post is positioned in the locked position and a mounting post of the adjacent space vehicle is positioned in a locked position.

13. The space vehicle of claim 12, wherein the engagement mechanism is contained within the stacking pillar.
